(19) United States
(12) Patent Application Publication
(10) Pub. No.: US 2024/0349935 A1
(43) Pub. Date: Oct. 24, 2024

(54) Coffee Tamping Mat

(71) Applicant: c/o Acaia Corporation, Alhambra, CA (US)

(72) Inventor: Rex Poway Tseng, Taipei (TW)

(21) Appl. No.: 18/629,207

(22) Filed: Apr. 8, 2024

Related U.S. Application Data
(60) Provisional application No. 63/497,561, filed on Apr. 21, 2023.

(51) Int. Cl. A47J 31/52; A47J 31/36

(52) U.S. Cl. CPC A47J 31/525; A47J 31/3671

(57) ABSTRACT

Systems and methods for detecting coffee tamping are provided. A coffee tamping detection system can include a mat having a body and a plurality of force sensors. The body can include a first surface and a second surface opposite to the first surface. The plurality of force sensors can be arranged between the first surface and the second surface and can be configured to measure a force exerted on the first surface. Furthermore, each force sensor of the plurality of force sensors can be configured to receive a respective input representing a portion of the force exerted on the respective force sensor. Each force sensor can be further configured to provide a respective sensor output representing a measurement of the portion of the force exerted on the respective force sensor.

### PRIORITY CLAIM

The present application claims the benefit of priority of U.S. Provisional Application Ser. No. 63/497,561, filed Apr. 21, 2023, titled “Coffee Tamping Mat,” which is incorporated by reference in its entirety and for all purposes.

### FIELD

Example aspects of the present disclosure relate generally to systems and methods for brewing coffee such as espresso. More particularly, the present disclosure relates to systems and methods for detecting coffee tamping.

### BACKGROUND

Espresso brewing is a method of brewing coffee that involves forcing pressurized water through finely ground coffee beans. Coffee tamping is an important step in the process of making espresso. Coffee tamping involves compressing the coffee grounds into a compact puck using a tool such as, e.g., a tamper. The quality of the resulting espresso shots greatly depends on the coffee tamping step.

### SUMMARY

Aspects and advantages of embodiments of the present disclosure will be set forth in part in the following description, or can be learned from the description, or can be learned through practice of the embodiments.

One example aspect of the present disclosure is directed to a system for coffee tamping detection. The system can include a mat. The mat can include a body having a first surface and a second surface that is opposite to the first surface. The mat can further include a plurality of force sensors arranged between the first surface and the second surface. The plurality of force sensors can be configured to measure a force exerted on the first surface of the mat. Furthermore, each force sensor of the plurality of force sensors can be configured to receive a respective input representing a portion of the force exerted on the respective force sensor. Each force sensor of the plurality of force sensors can be further configured to provide a respective sensor output representing a measurement of the portion of the force exerted on the respective force sensor.

In some embodiments, the system can include one or more displaying devices configured to provide a visual output representing the sensor outputs provided by the plurality of force sensors. In some embodiments, the one or more displaying devices can include a plurality of displaying devices, and each displaying device of the plurality of displaying devices can correspond to one force sensor of the plurality of force sensors.

In some embodiments, each of the one or more displaying devices can be configured to provide a first indication of whether the portion of the force exerted on the corresponding force sensor exceeds a first threshold value. Additionally, providing the first indication of whether the portion of the force exerted on the corresponding force sensor exceeds the first threshold value can include displaying a first color if the portion of the force exerted on the corresponding force sensor exceeds the first threshold value. Furthermore, providing the first indication of whether the portion of the force exerted on the corresponding force sensor exceeds the first threshold value can further include displaying a second color if the portion of the force exerted on the corresponding force sensor does not exceed the first threshold value. Even further, providing the first indication of whether the portion of the force exerted on the corresponding force sensor exceeds the first threshold value can further include not displaying any color if the portion of the force exerted on the corresponding force sensor does not exceed the first threshold value.

In some embodiments, each of the one or more displaying devices can be configured to provide a second indication if the portion of the force exerted on the corresponding force sensor exceeds a second threshold value. The first threshold value can be lower than the second threshold value.

In some embodiments, the one or more displaying devices can be arranged between the first surface and the second surface of the body of the mat. For instance, the body can include an opening exposing the visual output from the one or more displaying devices.

In some embodiments, the one or more displaying devices can be separated from the mat.

In some embodiments, the system can further include a processing module. The processing module can be configured to receive input data representing the sensor outputs by the plurality of force sensors. The processing module can be further configured to determine whether the input data has met a condition for a successful coffee tamping. The processing module can be further configured to provide output data in response to determining whether the input data has met the condition for a successful coffee tamping.

In some embodiments, to determine that the input data has met the condition for the successful coffee tamping, the processing module can be configured to determine that all of the sensor outputs provided by the plurality of force sensors exceed a first threshold value representing a minimum tamping force.

In some embodiments, to determine that the input data has met the condition for the successful coffee tamping, the processing module can be configured to determine that none of the outputs provided by the plurality of force sensors exceeds a second threshold value representing a maximum tamping force.

In some embodiments, to determine that the input data has met the condition for the successful coffee tamping, the processing module can be configured to determine that none of a difference between any two outputs provided by the plurality of force sensors exceeds a third threshold value representing a maximum force imbalance between two force sensors.

In some embodiments, to determine that the input data has not met the condition for the successful coffee tamping, the processing module can be configured to determine that at least one of the sensor outputs provided by the plurality of force sensors has not exceeded a first threshold value representing a minimum tamping force.

In some embodiments, to determine that the input data has not met the condition for the successful coffee tamping, the processing module can be configured to determine that at least one of the sensor outputs provided by the plurality of force sensors has exceeded a second threshold value representing a maximum tamping force.

In some embodiments, providing the output data further includes providing the output data to one or more displaying devices.

In some embodiments, the system further includes a communications module. The communications module can be configured to provide the output data from the processing module to the one or more displaying devices. The processing module and the communications module can be arranged between the first surface and the second surface of the body. In some embodiments, the communications module can be configured to provide the sensor outputs to the processing module.

In some embodiments, the first surface of the mat can be formed using a silicone material. The first surface of the mat can include a reference marking for receiving a coffee portafilter. In some embodiments, the plurality of force sensors can be arranged under the reference marking.

In some embodiments, the system can further include one or more robotic devices. The one or more robotic devices can be configured to hold a tamper and a coffee portafilter. The one or more robotic devices can be configured to apply the force exerted on the first surface of the mat by pressing the tamper on the coffee portafilter. The one or more robotic devices can be configured to stop the application of the force based at least in part on the sensor outputs of the plurality of force sensors.

Another example aspect of the present disclosure is directed to a method for detecting coffee tamping. The method can include obtaining, by a processing module comprising one or more processors, input data representing sensor outputs by a plurality of force sensors indicating portions of a force exerted on the plurality of force sensors arranged between two surfaces of a coffee tamping mat. The method can further include determining, by the processing module, whether the input data has met a condition for a successful coffee tamping. The method can further include, in response to determining whether the input data has met the condition for a successful coffee tamping, providing, by the processing module, output data.

In some implementations, determining whether the input data has met the condition for the successful coffee tamping further includes determining, by the processing module, that the input data has met the condition for the successful coffee tamping by determining that all of the sensor outputs provided by the plurality of force sensors exceed a first threshold value representing a minimum tamping force.

In some implementations, determining that the input data has met the condition for the successful coffee tamping further includes determining, by the processing module, that none of the outputs provided by the plurality of force sensors exceeds a second threshold value representing a maximum tamping force.

In some implementations, determining that the input data has met the condition for the successful coffee tamping further includes determining, by the processing module, that none of a difference between any two outputs provided by the plurality of force sensors exceeds a second threshold value representing a maximum force imbalance between two force sensors.

In some implementations, providing output data further includes, in response to determining that the input data has met the condition for a successful coffee tamping, providing one or more control signals, by the processing module to one or more robotic devices, to continue with a coffee-making process.

In some implementations, determining whether the input data has met the condition for the successful coffee tamping further includes determining, by the processing module, that the input data has not met the condition for the successful coffee tamping by determining that at least one of the sensor outputs provided by the plurality of force sensors has not exceeded a first threshold value representing a minimum tamping force.

In some implementations, providing output data further includes, in response to determining that the input data has not met the condition for a successful coffee tamping, providing one or more control signals, by the processing module to a robotic apparatus, to abort a coffee-making process.

In some implementations, providing output data further includes, in response to determining that the input data has not met the condition for a successful coffee tamping, providing one or more control signals, by the processing module to a robotic apparatus, to adjust the force exerted on the first surface of the coffee tamping mat.

In some implementations, the method can further include displaying, by one or more displaying devices, a visual output representing the sensor outputs by the plurality of force sensors.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a perspective view of an example coffee tamping apparatus according to example embodiments of the present disclosure;

FIG. 2 depicts an example coffee tamping detection system according to example embodiments of the present disclosure;

FIGS. 3A and 3B depict example force sensors for use in coffee tamping detection systems according to example embodiments of the present disclosure;

FIG. 4 depicts the example coffee tamping detection system according to example embodiments of the present disclosure;

FIG. 5 depicts the example coffee tamping detection system according to example embodiments of the present disclosure;

FIG. 6 depicts the example coffee tamping detection system according to example embodiments of the present disclosure;

FIG. 7 depicts the example coffee tamping detection system according to example embodiments of the present disclosure; and

FIG. 8 depicts a flow chart of an example method for detecting coffee tamping according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Espresso brewing is a method of brewing coffee that involves forcing pressurized water through finely ground coffee beans. More particularly, an example method for espresso brewing can include: grinding coffee beans to a fine, consistent texture using a coffee grinder (e.g., a burr grinder); filling a portafilter basket with the ground coffee; applying a force to the portafilter using a tamper to compress the coffee grounds into a compact puck; and attaching the portafilter to an espresso maker (e.g., espresso machine) to allow hot water to flow through the coffee grounds at high pressure (e.g., about 9 bars) for a specific amount of time (e.g., about 20 to 30 seconds) to produce the espresso.

Coffee tamping (e.g., with a tamper) is a step in the process of making espresso. Coffee tamping involves compressing the coffee grounds into a compact puck using a tool such as, e.g., a tamper. Coffee tamping serves to ensure an even extraction of coffee flavors and/or oils. Even extraction of the flavors and/or oils helps to produce good quality (e.g., rich and flavorful) espresso shots.

More particularly, an example coffee tamping method can include: placing the portafilter basket onto a level surface such as, e.g., a tamping mat; scooping coffee grounds into the portafilter basket until the portafilter basket is full; leveling the surface; holding the tamper perpendicular to the portafilter basket and applying firm, even pressure (e.g., about 30 psi) to compress the coffee grounds into a compact puck; moving the tamper in a twisting motion to ensure that the surface of the compact puck is level and smooth; and removing any excess coffee grounds from the rim of the portafilter basket.

A consistent tamping step helps to consistently produce quality espresso shots. However, a variety of issues commonly arise during the tamping step such as, e.g., uneven tamping, over-tamping, and/or under-tamping. Uneven tamping refers to situations where the coffee grounds are not evenly distributed (e.g., tampered) with the same amount of pressure. Uneven tamping can cause uneven water flow through the compact puck, resulting in a poor extraction and a weak and/or bitter taste. Over-tamping refers to situations where too much pressure is applied to the coffee grounds during tamping. Over-tamping can cause slowed and/or stalled extraction, resulting in a bitter taste. Under-tamping refers to situations where there is too little pressure applied during tamping. Under-tamping can cause the water to flow too quickly through the compact puck, resulting in a weak and/or watery taste. Furthermore, if the puck is not properly compacted, water will find a path of least resistance through the channels in the puck, resulting in an uneven extraction and a sour and/or bitter taste.

Accordingly, an apparatus or a system that can help provide a consistent and even tamping pressure to ensure that the coffee grounds are evenly distributed in the portafilter basket after tamping is desirable. The present disclosure provides a tamping mat that can detect a tamping force exerted on the tamping mat (e.g., from a tamper pressing on a portafilter). The tamping mat can provide one or more outputs (e.g., visual outputs, controlling outputs, etc.) to help achieve a proper tamping step (e.g., tamping with the appropriate pressure). Furthermore, the present disclosure can be used in both a manual setting (e.g., by a user) and/or a robotic espresso-making setting (e.g., by a robotic machine).

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

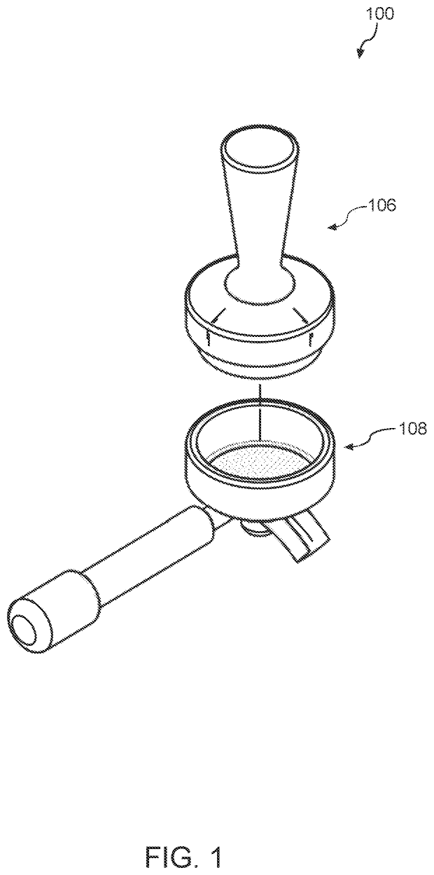

FIG. 1 depicts a perspective view of an example coffee tamping apparatus according to example embodiments of the present disclosure. Tamping apparatus 100 can include a tamper 106 and a coffee portafilter 108 and can be used to brew espresso. For instance, the portafilter 108 can be filled with ground coffee. The tamper 106 can be used to apply a force (e.g., pressure) to the portafilter 108 to compress the coffee grounds into a compact puck (not shown). The portafilter 108 can then be attached to an espresso maker (not shown) (e.g., espresso machine) to allow hot water to flow through the coffee grounds at a high pressure (e.g., about 9 bars) for a specific amount of time. In this way, the tamping apparatus 100 can be used to produce espresso.

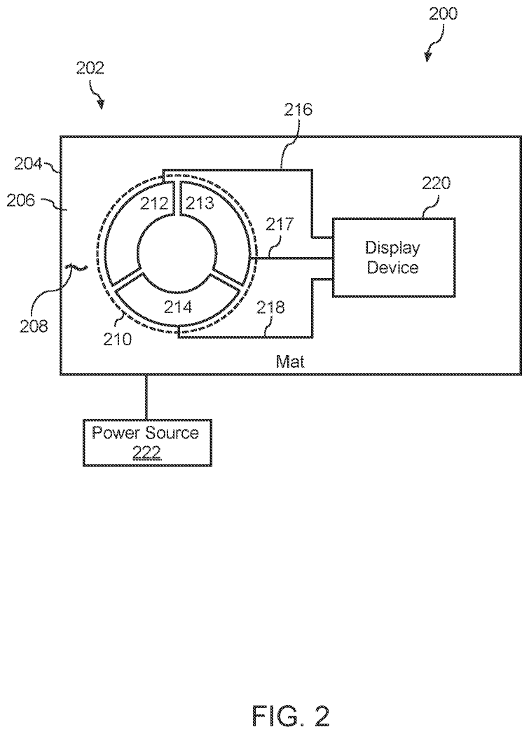

FIG. 2 depicts an example system for coffee tamping detection according to example embodiments of the present disclosure. Coffee tamping detection system 200 can include a mat 202. The mat 202 can include a body 204 having a first surface 206 and a second surface 208 opposite the first surface 206. In some embodiments, the first surface 206 of mat 202 can be formed using, e.g., a silicone material. In some embodiments, the first surface 206 of mat 202 can include a reference marking 210 for receiving a coffee portafilter (not shown) (e.g., portafilter 108).

The mat 202 can further include a plurality of force sensors 212, 213, 214. In some embodiments, the plurality of force sensors 212, 213, 214 can be arranged between the first surface 206 and the second surface 208 of mat 202. Additionally and/or alternatively, the plurality of force sensors 212, 213, 214 can be arranged under the reference marking 210 of the mat 202. It should be noted that coffee tamping detection system 200 is depicted with three force sensors for purposes of illustration. Those of ordinary skill in the art will understand that coffee tamping detection system 200 can include any number of force sensors without deviating from the scope of the present disclosure.

Furthermore, the plurality of force sensors 212, 213, 214 can be configured to measure a force exerted on the first surface 206 of mat 202. More particularly, each of the plurality of force sensors 212, 213, 214 can be configured to receive a respective input representing a portion of the force exerted on the respective force sensor of the plurality of force sensors 212, 213, 214. Each of the plurality of force sensors 212, 213, 214 can be further configured to provide a respective sensor output 216, 217, 218 representing the portion of the force exerted on the respective force sensor of the plurality of force sensors 212, 213, 214. Each respective sensor output 216, 217, 218 can be stored in a memory (not shown) of the coffee tamping detection system 200.

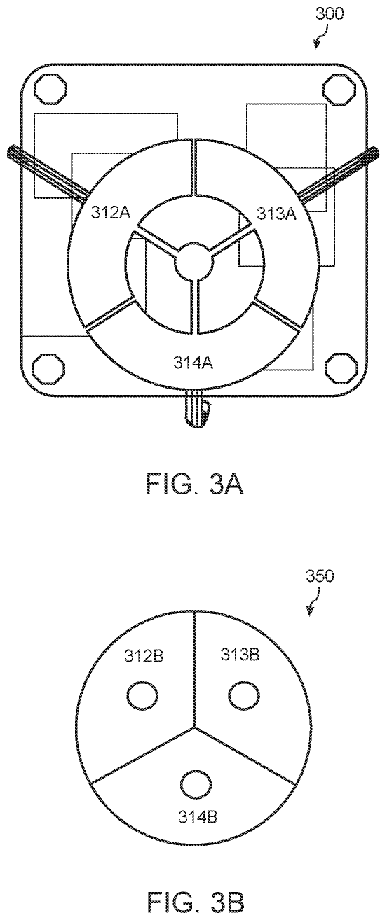

As an illustrative example, FIGS. 3A and 3B depict example force sensors (e.g., pressure sensors) for use in coffee tamping detection systems according to example embodiments of the present disclosure. FIG. 3A depicts a first embodiment 300 of a first plurality of force sensors 312A, 313A, 314A. FIG. 3B depicts a second embodiment 350 of a second plurality of force sensors 312B, 313B, 314B.

Referring again to FIG. 2, the coffee tamping detection system 200 can further include one or more displaying devices 220. As will be discussed in greater detail below, the one or more displaying devices 220 can be configured to provide a visual output representing the respective sensor output 216, 217, 218 provided by the plurality of force sensors 212, 213, 214. For instance, in some embodiments, the one or more displaying devices 220 can include a plurality of displaying devices corresponding to each of the plurality of force sensors 212, 213, 214, respectively. In some embodiments, the one or more displaying devices 220 can be arranged between the first surface 206 and the second surface 208 of the body 204 of the mat 202. In some embodiments, the body 204 can include an opening (not shown) exposing the visual output from the one or more displaying devices 220. Additionally and/or alternatively, as will be discussed in greater detail below, the coffee tamping detection system 200 can be arranged such that the one or more displaying devices 220 are separated from the mat.

Coffee tamping detection system 200 can further include one or more power sources 222. Those having ordinary skill in the art will appreciate that any suitable power source can be used without deviating from the scope of the present disclosure.

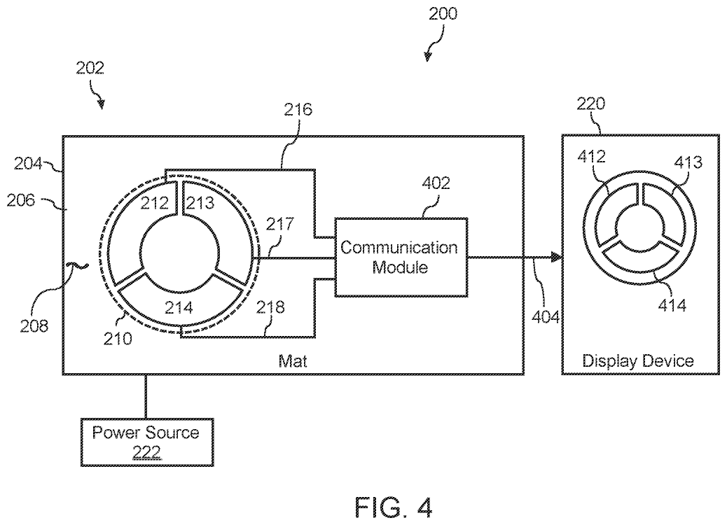

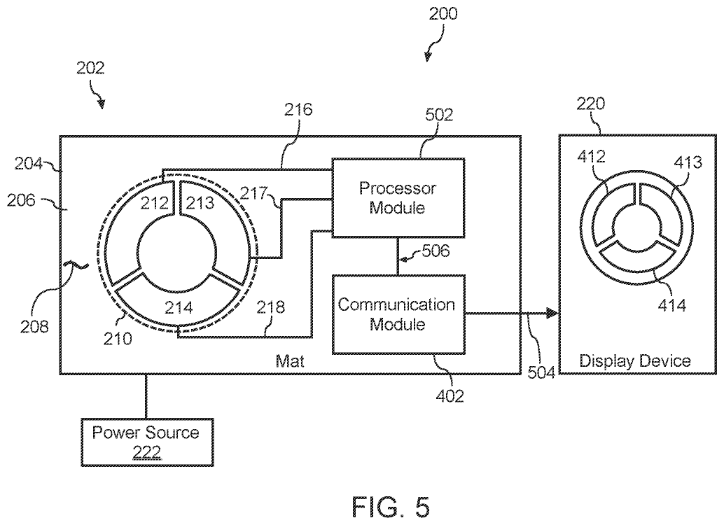

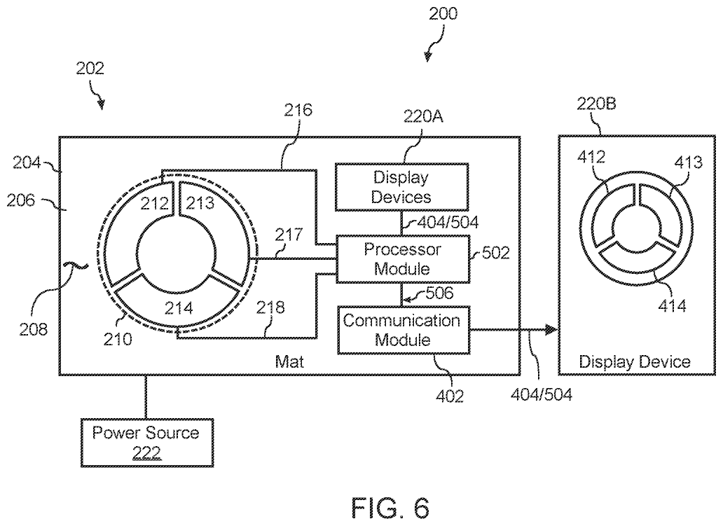

FIGS. 4-6 depict the example system 200 for coffee tamping detection according to example embodiments of the present disclosure. As noted above with reference to FIG. 2, in some embodiments, the one or more displaying devices 220 can be arranged between the first surface 206 and the second surface 208 of the body 204 of the mat 202. Additionally and/or alternatively, as shown in FIGS. 4 and 5, coffee tamping detection system 200 can be arranged such that the one or more displaying devices 220 (e.g., mobile phone, tablet, etc.) are separated from the mat 202. Additionally and/or alternatively, as shown in FIG. 6, coffee tamping detection system 200 can be arranged such that the one or more displaying devices 220 are arranged both between the first surface 206 and the second surface 208 of the mat 202 (e.g., displaying devices 220A) and separated from the mat 202 (e.g. displaying devices 220B).

As noted above, in some embodiments, the one or more displaying devices 220 can include a plurality of displaying devices 412, 413, 414 corresponding to each of the plurality of force sensors 212, 213, 214, respectively. The plurality of displaying devices 412, 413, 414 can be any suitable display device (e.g., LED, OLED, QLED, LCD, TFT, etc.).

Each of the plurality of displaying devices 412, 413, 414 can be configured to provide a visual output (e.g., red light, yellow light, green light) representing the respective sensor output 216, 217, 218 provided by the plurality of force sensors 212, 213, 214. In some embodiments, each displaying device 412, 413, 414 can be configured to provide a first indication of whether the portion of the force exerted on the corresponding force sensor of the plurality of force sensors 212, 213, 214 exceeds a first threshold value (e.g., a first force threshold value). For instance, each displaying device 412, 413, 414 can display a first color (e.g., green) if the portion of the force exerted on the corresponding force sensor 212, 213, 214 exceeds the first threshold value. Each displaying device 412, 413, 414 can further display a second color (e.g., yellow) if the portion of the force exerted on the corresponding force sensor 212, 213, 214 does not exceed the first threshold value. Additionally and/or alternatively, each displaying device 412, 413, 414 can be configured to not display any color if the portion of the force exerted on the corresponding force sensor 212, 213, 214 does not exceed the first threshold value.

Each displaying device 412, 413, 414 can be further configured to provide a second indication of whether the portion of the force exerted on the corresponding force sensor of the plurality of force sensors 212, 213, 214 exceeds a second threshold value (e.g., a second force threshold value). For instance, each displaying device 412, 413, 414 can display a third color (e.g., red) if the portion of the force exerted on the corresponding force sensor 212, 213, 214 exceeds the second threshold value. In some embodiments, the first threshold value can be lower than the second threshold value.

Coffee tamping detection system 200 can further include a communications module 402 and a processing module 502. In some embodiments, the communications module 402 and the processing module 502 can be arranged between the first surface 206 and the second surface 208 of the body 204 of the mat 202. Furthermore, the one or more displaying devices 220 can be communicatively coupled to the mat 202 via a wireless connection 404 to the communications module 402. Additionally and/or alternatively, the one or more displaying devices 220 can be communicatively coupled to the mat 202 via a wired connection 504 to the communications module 402. Furthermore, the communications module 402 can be communicatively coupled to the processing module 502.

The processing module 502 can be configured to receive input data representing the respective sensor outputs 216, 217, 218 from the plurality of force sensors 212, 213, 214. For instance, the processing module 502 can store the data representing the respective sensor outputs 216, 217, 218 from the plurality of force sensors 212, 213, 214 in a memory (not shown). As will be discussed in greater detail below, in some embodiments, each of the displaying devices 412, 413, 414 can be configured to retrieve the data representing the respective sensor outputs 216, 217, 218 from the plurality of force sensors 212, 213, 214 from the memory of the processing module 502. In some embodiments, the communications module 402 can be configured to provide the sensor outputs 216, 217, 218 to the processing module 502.

The processing module 502 can be further configured to determine whether the input data (e.g., sensor output 216, 217, 218) has met a condition for a successful coffee tamping. For instance, the processing module 502 can be configured to determine that the input data (e.g., sensor output 216, 217, 218) has met the condition for the successful coffee tamping by determining that all of the sensor outputs 216, 217, 218 provided by the plurality of force sensors 212, 213, 214 exceed a first threshold value (e.g., first force threshold value) representing a minimum tamping force. Additionally and/or alternatively, the processing module 502 can be configured to determine that the input data (e.g., sensor output 216, 217, 218) has met the condition for the successful coffee tamping by determining that none of the sensor outputs 216, 217, 218 provided by the plurality of force sensors 212, 213, 214 exceed a second threshold value (e.g., second force threshold value) representing a maximum tamping force. Additionally and/or alternatively, the processing module 502 can be configured to determine that the input data (e.g., sensor output 216, 217, 218) has met the condition for the successful coffee tamping by determining that none of a difference between any two of the sensor outputs 216, 217, 218 provided by the plurality of force sensors 212, 213, 214 exceeds a third threshold value (e.g., third force threshold value) representing a maximum force imbalance between the respective force sensors of the plurality of force sensors 212, 213, 214.

Moreover, the processing module 502 can be configured to determine that the input data (e.g., sensor output 216, 217, 218) has not met the condition for the successful coffee tamping by determining that at least one of the sensor outputs 216, 217, 218 provided by the plurality of force sensors 212, 213, 214 has not exceeded the first threshold value representing the minimum tamping force. Additionally and/or alternatively, the processing module 502 can be configured to determine that the input data (e.g., sensor output 216, 217, 218) has not met the condition for the successful coffee tamping by determining that at least one of the sensor outputs 216, 217, 218 provided by the plurality of force sensors 212, 213, 214 has exceeded the second threshold value representing the maximum tamping force.

Furthermore, in response to determining whether the input data has met the condition for a successful coffee tamping, the processing module 502 can be configured to provide output data 506 to the one or more displaying devices 412, 413, 414. More particularly, in some embodiments, the communications module 402 can be configured to provide the output data 506 from the processing module 502 to the one or more displaying devices 412, 413, 414.

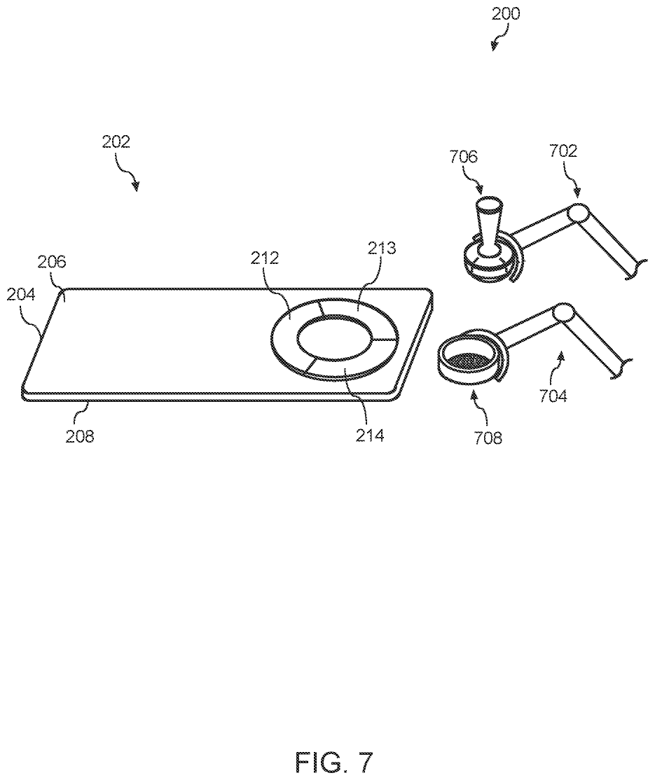

FIG. 7 depicts the example system 200 for coffee tamping detection according to example embodiments of the present disclosure. As shown, in some embodiments, coffee tamping detection system 200 can include one or more robotic devices 702, 704. The robot devices 702, 704 can be a robot arm that can extend and contract in length. The one or more robotic devices 702, 704 can be configured to hold a tamper 706 (e.g., tamper 106) and a coffee portafilter 708 (e.g., portafilter 108). For instance, as shown, robotic device 702 can be configured to hold tamper 706, and robotic device 704 can be configured to hold portafilter 708.

The one or more robotic devices 702, 704 can be further configured to apply a force exerted on the first surface 206 of the mat 202 by pressing the tamper 706 on the coffee portafilter 708. For instance, as shown, robotic device 702 can be configured to press the tamper 706 on the coffee portafilter 708 held by robotic device 704. In this way, robotic device 702 and robotic device 704 can be configured to apply the force exerted on the first surface 206 of the mat 202.

The one or more robotic devices 702, 704 can be further configured to stop the application of force based at least in part on the respective sensor output 216, 217, 218 (not shown in FIG. 7) provided by the plurality of force sensors 212, 213, 214.

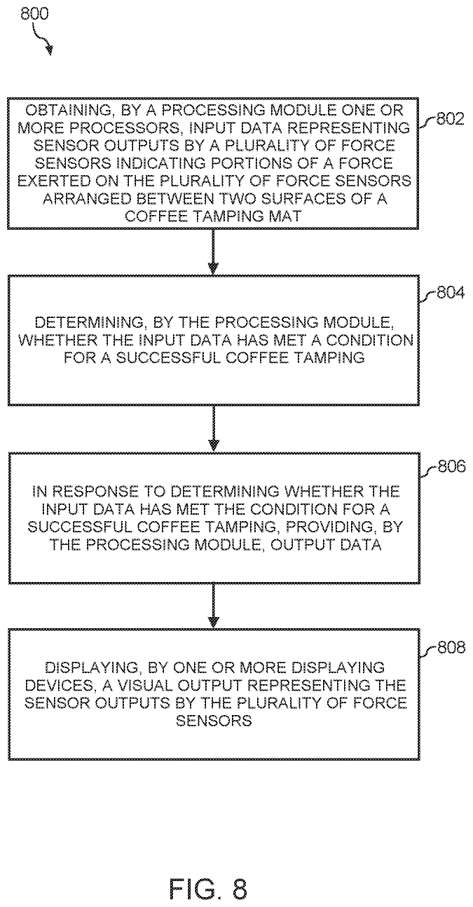

FIG. 8 depicts a flow chart of an example method for detecting coffee tamping according to example embodiments of the present disclosure. FIG. 8 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. Additionally, the method 800 is generally discussed with reference to the tamping apparatus 100 and the coffee tamping detection system 200 described above with reference to FIGS. 1-7. However, it should be understood that aspects of the present method 800 can find application with any suitable tamping apparatus and/or coffee tamping detection system.

The method 800 can include, at (802), obtaining, by a processing module comprising one or more processors, input data representing sensor outputs by a plurality of force sensors indicating portions of a force exerted on the plurality of force sensors arranged between two surfaces of a coffee tamping mat.

As an illustrative example, the processing module 502 can be configured to obtain input data representing sensor outputs 216, 217, 218 by the plurality of force sensors 212, 213, 214. The input data can indicate portions of a force exerted on the plurality of force sensors 212, 213, 214. As noted above, the plurality of force sensors 212, 213, 214 can be arranged between two surfaces (e.g., first surface 206 and second surface 208) of the coffee tamping mat 202.

Referring again to FIG. 8, the method 800 can include, at (804), determining, by the processing module, whether the input data has met a condition for a successful coffee tamping. For instance, the method 800 can include determining, by the processing module, that the input data has met the condition for the successful coffee tamping by determining that all of the sensor outputs provided by the plurality of force sensors exceed a first threshold value representing a minimum tamping force. Additionally and/or alternatively, the method 800 can include determining, by the processing module, that the input data has met the condition for the successful coffee tamping by determining that none of the outputs provided by the plurality of force sensors exceed a second threshold value representing a maximum tamping force. Additionally and/or alternatively, the method 800 can include determining, by the processing module, that the input data has met the condition for the successful coffee tamping by determining that none of a difference between any two outputs provided by the plurality of force sensors exceeds a second threshold value representing a maximum force imbalance between at least two of the plurality of force sensors.

Moreover, the method 800 can include determining, by the processing module, that the input data has not met the condition the successful coffee tamping by determining, by the processing module, that at least one of the sensor outputs provided by the plurality of force sensors has not exceeded the first threshold value representing the minimum tamping force. In this way, the processing module can determine that the input data has met the condition for the successful coffee tamping based at least in part on the data output by the plurality of force sensors and one or more system metrics (e.g., minimum tamping force, maximum tamping force, maximum force imbalance).

As an illustrative example, the processing module 502 can be configured to determine whether the input data representing sensor outputs 216, 217, 218 by the plurality of force sensors 212, 213, 214 has met a condition for a successful coffee tamping based at least in part on one or more threshold values stored in the memory.

The processing module 502 can determine that the input data representing sensor outputs 216, 217, 218 by the plurality of force sensors 212, 213, 214 has met the condition for the successful coffee tamping by determining that all of the sensor outputs 216, 217, 218 provided by the plurality of force sensors 212, 213, 214 exceed a first threshold value representing a minimum tamping force.

Additionally and/or alternatively, the processing module 502 can determine that the input data representing sensor outputs 216, 217, 218 by the plurality of force sensors 212, 213, 214 has met the condition for the successful coffee tamping by determining that none of the sensor outputs 216, 217, 218 provided by the plurality of force sensors 212, 213, 214 exceed a second threshold value representing a maximum tamping force.

Additionally and/or alternatively, the processing module 502 can determine that the input data representing sensor outputs 216, 217, 218 by the plurality of force sensors 212, 213, 214 has met the condition for the successful coffee tamping by determining that none of a difference between any two of the sensor outputs 216, 217, 218 provided by the plurality of force sensors 212, 213, 214 exceed a third threshold value representing a maximum force imbalance between at least two of the plurality of force sensors 216, 217, 218.

Additionally and/or alternatively, the processing module 502 can determine that the input data representing sensor outputs 216, 217, 218 by the plurality of force sensors 212, 213, 214 has not met the condition for the successful coffee tamping by determining that at least one of the sensor outputs 216, 217, 218 provided by the plurality of force sensors 212, 213, 214 has not exceeded the first threshold value representing the minimum tamping force.

Referring again to FIG. 8, the method 800 can include, at (806), in response to determining whether the input data has met the condition for a successful coffee tamping at (804), providing, by the processing module, output data. For instance, in response to determining that the input data has met the condition for a successful coffee tamping, the method 800 can include providing one or more control signals, by the processing module to one or more robotic devices, to continue with a coffee-making process. Additionally and/or alternatively, in response to determining that the input data has not met the condition for a successful coffee tamping, the method 800 can include providing one or more control signals, by the processing module to the robotic apparatus, to abort the coffee-making process. Additionally and/or alternatively, in response to determining that that the input data has not met the condition for a successful coffee tamping, the method 800 can include providing one or more control signals, by the processing module to the robotic apparatus, to adjust the force exerted on the first surface of the coffee tamping mat.

As an illustrative example, the processing module 502 can be configured to provide output data 506 in response to determining whether the input data representing sensor outputs 216, 217, 218 by the plurality of force sensors 212, 213, 214 has met a condition for a successful coffee tamping.

For instance, in response to determining that the input data has met the condition for a successful coffee tamping, the processing module 502 can be configured to provide one or more control signals to the coffee tamping detection system 200. The one or more control signals can include signals indicative of an instruction to the coffee tamping detection system 200 to continue with the coffee-making process. For instance, in some embodiments, the processing module 502 can provide the one or more control signals to the robotic devices 702, 704 to continue with the coffee-making process.

Likewise, in response to determining that the input data has not met the condition for a successful coffee tamping, the processing module 502 can be configured to provide one or more control signals to the coffee tamping detection system 200. For instance, the one or more control signals can further include signals indicative of an instruction to the coffee tamping detection system 200 to abort the coffee-making process. Additionally and/or alternatively, the one or more control signals can further include signals indicative of an instruction to the coffee tamping detection system 200 to adjust a force exerted on the first surface 206 of the coffee tamping mat 202.

Referring again to FIG. 8, the method 800 can include, at (808), displaying, by one or more displaying devices, a visual output representing the sensor outputs by the plurality of force sensors at (806).

As an illustrative example, the one or more displaying devices 220 can be configured to provide a visual output representing the sensor outputs 216, 217, 218 provided by the plurality of force sensors 212, 213, 214. As noted above, the processing module 502 can be configured to provide the data indicative of the sensor outputs 216, 217, 218 provided by the plurality of force sensors 212, 213, 214 to the one or more displaying devices.

As noted above, in some embodiments, the one or more displaying devices 220 can be arranged between the first surface 206 and the second surface 208 of the mat 202. In such embodiments, the one or more displaying devices 220 can be provided on the mat 202 itself.

Additionally and/or alternatively, the one or more displaying devices 220 can be separated from the mat 202. In such embodiments, each of the displaying devices 412, 413, 414 can be provided on, e.g., a smartphone and/or tablet, and the one or more displaying devices 220 can be communicatively coupled to the mat 202 via the communications module 402.

Furthermore, as noted above, each of the displaying devices 412, 413, 414 can be configured to provide an indication (e.g., red light, yellow light, green light) representing the respective sensor output 216, 217, 218 provided by the plurality of force sensors 212, 213, 214. More specifically, displaying device 412 can be configured to provide an indication representing the sensor output 216 provided by the force sensor 212, displaying device 413 can be configured to provide an indication representing the sensor output 217 provided by the force sensor 213, and displaying device 414 can be configured to provide an indication representing the sensor output 218 provided by the force sensor 218. In this way, example aspects of the present disclosure can provide visual representations of various aspects (e.g., metrics) of the coffee tamping detection system 200 to a user of the coffee tamping detection system 200.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A system for coffee tamping detection, the system comprising:
a mat comprising:
a body comprising a first surface; and a second surface that is opposite to the first surface; and
a plurality of force sensors arranged between the first surface and the second surface, the plurality of force sensors configured to measure a force exerted on the first surface of the mat,
wherein each force sensor of the plurality of force sensors is configured to:
receive a respective input representing a portion of the force exerted on the respective force sensor; and
provide a respective sensor output representing a measurement of the portion of the force exerted on the respective force sensor.

2. The system of claim 1, further comprising one or more displaying devices configured to provide a visual output representing the sensor outputs provided by the plurality of force sensors, wherein the one or more displaying devices comprise a plurality of displaying devices, and wherein each displaying device of the plurality of displaying devices corresponds to one force sensor of the plurality of force sensors.

3. The system of claim 2, wherein each of the one or more displaying devices is configured to provide a first indication of whether the portion of the force exerted on the corresponding force sensor exceeds a first threshold value.

4. The system of claim 3, wherein providing the first indication of whether the portion of the force exerted on the corresponding force sensor exceeds the first threshold value further comprises:
displaying a first color if the portion of the force exerted on the corresponding force sensor exceeds the first threshold value; and
displaying a second color if the portion of the force exerted on the corresponding force sensor does not exceed the first threshold value.

5. The system of claim 3, wherein each of the one or more displaying devices is configured to provide a second indication if the portion of the force exerted on the corresponding force sensor exceeds a second threshold value, wherein the first threshold value is lower than the second threshold value.

6. The system of claim 1, further comprising:
a processing module configured to:
receive input data representing the sensor outputs by the plurality of force sensors;
determine whether the input data has met a condition for a successful coffee tamping; and
in response to determining whether the input data has met the condition for a successful coffee tamping, provide output data.

7. The system of claim 6, wherein determining whether the input data has met the condition for the successful coffee tamping further comprises determining that the input data has met the condition for the successful coffee tamping by determining that all of the sensor outputs provided by the plurality of force sensors exceed a first threshold value representing a minimum tamping force.

8. The system of claim 7, wherein determining that the input data has met the condition for the successful coffee tamping further comprises determining that none of the outputs provided by the plurality of force sensors exceeds a second threshold value representing a maximum tamping force.

9. The system of claim 7, wherein determining that the input data has met the condition for the successful coffee tamping further comprises determining that none of a difference between any two outputs provided by the plurality of force sensors exceeds a third threshold value representing a maximum force imbalance between two force sensors.

10. The system of claim 6, wherein determining whether the input data has met the condition for the successful coffee tamping further comprises determining that the input data has not met the condition for the successful coffee tamping by determining that at least one of the sensor outputs provided by the plurality of force sensors has not exceeded a first threshold value representing a minimum tamping force.

11. The system of claim 10, wherein determining the input data has not met the condition for the successful coffee tamping further comprises determining that at least one of the sensor outputs provided by the plurality of force sensors has exceeded a second threshold value representing a maximum tamping force.

12. The system of claim 6, further comprising a communications module configured to provide the output data from the processing module to one or more displaying devices, wherein the processing module and the communications module are arranged between the first surface and the second surface of the body.

13. The system of claim 1, wherein the first surface of mat includes a reference marking for receiving a coffee portafilter, and wherein the plurality of force sensors are arranged under the reference marking.

14. The system of claim 1, further comprising one or more robotic devices configured to:
hold a tamper and a coffee portafilter;
apply the force exerted on the first surface of the mat by pressing the tamper on the coffee portafilter; and
stop the application of the force based at least on the sensor outputs of the plurality of force sensors.

15. A method for detecting coffee tamping, comprising:
obtaining, by a processing module comprising one or more processors, input data representing sensor outputs by a plurality of force sensors indicating portions of a force exerted on the plurality of force sensors arranged between two surfaces of a coffee tamping mat;
determining, by the processing module, whether the input data has met a condition for a successful coffee tamping; and
in response to determining whether the input data has met the condition for a successful coffee tamping, providing, by the processing module, output data.

16. The method of claim 15, wherein determining whether the input data has met the condition for the successful coffee tamping further comprises determining, by the processing module, that the input data has met the condition for the successful coffee tamping by determining that all of the sensor outputs provided by the plurality of force sensors exceed a first threshold value representing a minimum tamping force.

17. The method of claim 16, wherein determining that the input data has met the condition for the successful coffee tamping further comprises determining, by the processing module, that none of the outputs provided by the plurality of force sensors exceeds a second threshold value representing a maximum tamping force.

18. The method of claim 16, wherein determining that the input data has met the condition for the successful coffee tamping further comprises determining, by the processing module, that none of a difference between any two outputs provided by the plurality of force sensors exceeds a second threshold value representing a maximum force imbalance between two force sensors.

19. The method of claim 16, wherein providing output data further comprises in response to determining that the input data has met the condition for a successful coffee tamping, providing one or more control signals, by the processing module to one or more robotic devices, to continue with a coffee-making process.

20. The method of claim 15, wherein determining whether the input data has met the condition for the successful coffee tamping further comprises determining, by the processing module, that the input data has not met the condition for the successful coffee tamping by determining that at least one of the sensor outputs provided by the plurality of force sensors has not exceeded a first threshold value representing a minimum tamping force.
